(19) United States
(12) Patent Application Publication
(10) Pub. No.: US 2012/0050048 A1
(43) Pub. Date: Mar. 1, 2012

(54) Child Locator

(76) Inventors: Johnston Sandra, Miami, FL (US); Luz E. LaTorre, Miami, FL (US)

(21) Appl. No.: 12/871,627

(22) Filed: Aug. 30, 2010

(51) Int. Cl. G08B 23/00; G01S 19/51

(52) U.S. Cl. 340/573.4; 342/357.34

(57) ABSTRACT

An electronic locator system comprised of at least a beacon, a display assembly and a key. The beacon receives a GPS signal, calculates its position and wirelessly re-broadcasts the encrypted position. The display assembly is only able to receive and decrypt the encrypted position information when in close proximity to the key. The location of the beacon is thereby only available to the person who has both the display assembly and the key. Because both the key and the display assembly must be in close proximity to each other the likelihood of an unauthorized person being able to receive location of the beacon is reduced. Optionally, the display assembly may have alert parameters to notify the user of the display assembly when the beacon has crossed a predetermined boundary.

### BACKGROUND OF THE INVENTION

1. Field of the Invention

The present invention relates to global positioning system locator devices, and more particularly, to a multi-component system of devices to locate and monitor people.

2. Description of the Related Art

Several designs for global positioning system devices have been designed in the past. None of them, however, include a secure key enabled hand held device that wirelessly receives location information from a discrete locator beacon and plots that location on map viewable on the handheld device. Further, none are known to provide an alert when the locator beacon passes a predetermined distance from the handheld device and/or a predetermined boundary.

Devices are known that plot their location on a handheld digital map, such as on a portable global positioning system (GPS) unit or cellular phone. None are known to wirelessly transmit the location of a GPS beacon to a remote device that can only interpret the location of the beacon when unlocked with a physical key-device and then will display the location of the beacon and also will monitor and notify the user if the beacon crosses a predetermined boundary.

Other patents describing the closest subject matter provide for a number of more or less complicated features that fail to solve the problem in an efficient and economical way. None of these patents suggest the novel features of the present invention.

### SUMMARY OF THE INVENTION

It is a primary object of this invention to provide a child's location securely and accurately to a parent to enhance the ability of a parent to protect a child.

It is one of the main objects of the present invention to provide a device that aids a parent supervising a child to locate that child precisely in real time.

It is another object of this invention to provide a device that can alert a caregiver when the person they are caring for crosses a pre-defined perimeter.

It is an object of the present invention to provide a device that can work equally well when monitoring a wandering dementia patient as well as a child to aid in protecting that person.

It is still another object of the present invention to provide a device that will only display the location of the beacon when the key-device is paired with the display unit.

It is yet another object of this invention to provide such a device that is inexpensive to manufacture and maintain while retaining its effectiveness.

Further objects of the invention will be brought out in the following part of the specification, wherein detailed description is for the purpose of fully disclosing the invention without placing limitations thereon.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents a plan view of human hand wearing a variation of a beacon device.

FIG. 2 shows a perspective view of an example of a handheld device displaying a map and beacon location icon.

FIG. 3 illustrates a plan view of a human hand wearing a contemplated example of a key-device.

FIG. 4 is a plan view representation of an alternate beacon integrated into a common shirt.

FIG. 5 is a flow chart of an example of the action and interaction between the various components.

### DETAILED DESCRIPTION OF THE PREFERRED EMBODIMENT

Parents sometimes have difficulty keeping track of their children. Particularly in busy places such as a mall or a sporting event, children can easily wander off and become lost. This can cause a distressing condition on both the parent and the child. A device is needed to help a parent quickly and easily locate their child.

In some instances as children become more mature a parent may allow a child to be outside of visual range yet still want to monitor the child's location. For example, if a parent and child are at a mall a parent may want to know if the child exits the mall. Obviously this could indicate a safety concern if the child for some reason, on their own or with another, leaves the boundary of the building. The present device provides features for alerting the parent when a pre-set boundary is crossed.

In another example, while camping outdoors, a child may wander and explore. Sometimes the child could wander out of voice range or sight range. The present invention could not only be pre-set to create an alert when the beacon crosses a predetermined geographical perimeter but also could alert when the beacon exceeds a predetermined radius from the receiver. This feature could be more useful, for example, when hiking or in a moving group where distance from the parent is more important that specific geographical location.

Similar to the parent-child benefits, the device could also be used in a nursing home or assisted living facility scenario. Nurses report that patients with dementia or other cognitive impairments can become disoriented and lost. Some patients or residents of these facilities also sometimes have the propensity to wander away from supervision. The utilization of a device such as the present invention to notify a caregiver that a particular patient has crossed a particular threshold distance or entered into an area that may present a higher risk (such as a highway right of way) and might be in need of assistance can have the ability to reduce the risk to injury of a particularly at need population with minimal invasion of personal privacy and with minimal effort expended by the caregiver in monitoring the patient.

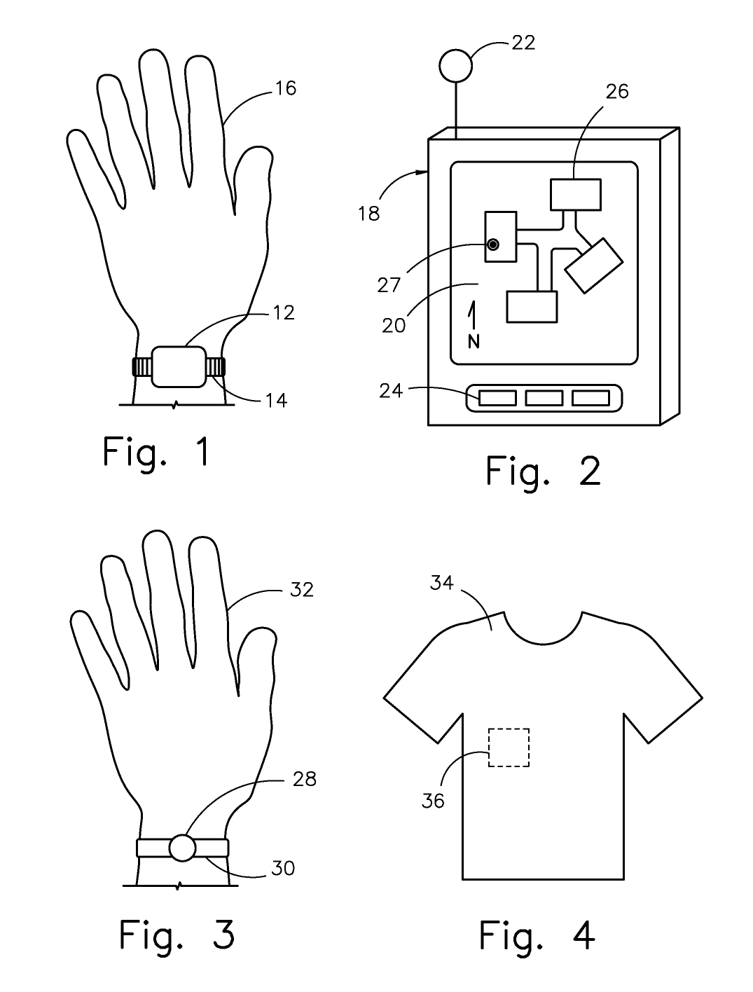

Referring now to the drawings, where a primary variation of the present invention is generally shown in FIGS. 1-3, it can be observed that it basically includes, inter alia, a beacon 12, a strap 14, a receiver assembly 18, a display 20, an antenna 22, controls 24, a map 26, a locator icon 27, a key 28, and a strap 30. Also shown for contextual understanding are a hand 16 in FIG. 1 and a hand 32 in FIG. 3.

Generally, a preferred embodiment of the invention comprises, inter alia, three principal elements: a beacon 12, a receiver assembly 18 and a key 28. Other features are shown in the drawings or described in the specification show optional enhancements to improve the efficacy of the invention and how it performs in alternate applications. The features are shown conceptually as alternate variations for components performing similar functions are readily apparent even if not shown in the drawings or described in this specification.

The beacon 12 at a minimum determines its present location and transmits that location information. In the embodiment demonstrated in FIG. 1 the beacon 12 is held onto the wrist or hand 16 of the individual to be monitored. The beacon 12 is held onto the hand 16 by means of a strap 14, similar to a wrist watch. Optionally, the beacon could provide other features such as a clock feature.

Other features could include, for example, a two way communication means for voice, data, email, video phone, text message or other available means of communication. This could allow the person monitoring the beacon 12 to query the wearer of the beacon 12 to determine if assistance is required or to offer directional or instructional information to the wearer of the beacon 12.

The means of transmission could include any method capable of sending at least geographical location of the beacon 12 to the anticipated distance of the receiver assembly 18. For example, it could be wi-fi, Bluetooth, cellular, citizens band (CB) radio, pager system, internet or any other designated frequency or protocol available and suited for such means of communication.

Multiple means of communication could also be utilized either simultaneously or in conjunction with others. By means of example, if in an area where wi-fi internet is available, the signal emitting from the beacon carrying the geographical location information could be sent from the beacon 12 to the wi-fi network and a text message, email or other data stream could be routed and forwarded over the internet and then to the receiver assembly 18 wirelessly.

An alternate means of communication of the geographical location information from the beacon 12 to the receiver assembly 18 could be over any of the various cellular networks. This is a more attractive method where a two way duplex voice communication feature is combined with the beacon 12 device.

In one variation the wireless link, or series of links, between the beacon 12 and receiver assembly 18 can be intermittent to conserve bandwidth. For example, the beacon 12 could periodically send geographical location information at pre-determined intervals. Said intervals could vary from a few seconds to several minutes depending on the application of the invention.

Alternatively, for some applications, there may be constant real-time streaming geographical location information sent from the beacon 12 to the receiver assembly 18. The required bandwidth would be minimal if limited to only geographical information. The signal could be further compressed digitally to avoid over burdening any particular network.

In a preferred variation of the invention the receiver assembly 18 has a display 20 that can show a variety of useful information. In the example shown in FIG. 2, a map 26 is on the display 20. The map 26 in this example is of a shopping mall. The location of the beacon 12 is represented by a locator 27 bullseye. Although not depicted in FIG. 2, the location of the receiver assembly itself could also be plotted on the map 26 to provide a graphical indication of the relative location and distance between the beacon 12, representing the child, and the receiver assembly 18, representing the parent.

Obviously other maps could be useful in other situations such as a street map, topographical map, bathymetric chart, range map or other map. Said range map might include, for example, a series of concentric rings where the center point represents the GPS determined location of the receiver assembly 20 itself and the locator 27 represents the relative location of the beacon 12. The concentric rings may be set at predetermined ranges, for example, one hundred meters, two hundred meters and so on, such that the user of the receiver assembly can easily determine how far the beacon is the position of the receiver assembly. This set up could be useful for the above mentioned moving group or hiking scenario where distance between child and parent is more important than determining whether the child crossed a predetermined boundary.

Referring again to the map 26 of the shopping mall shown in FIG. 2, in some applications it may be beneficial to have a specific predetermined boundary that the beacon 12 is allowed to occupy. In other words, a parent could permit the child wearing the beacon 12 to freely roam the inside of the shopping mall with friends but if the child exits the shopping mall and crosses the predetermined boundary, defined in this example as the perimeter of the shopping mall, then the parent is notified by an alarm.

Said alarm could be an audible and/or visible alarm, a text message or email to the parent or mall security or notification directly to the beacon 12 indicating that the system has detected that the boundary perimeter has been breached.

In a preferred variation of the invention a key 28 is provided to add a measure of security to limit access to the location of the beacon 12. The key 28 is provided so that only the person having the key 28 can access information about the location of the beacon 12. Generally, the beacon continually or intermittently broadcasts its positional information. The problem arises then that anyone with a receiver could potentially access the information as to where a child is located. To limit who can access that positional information, the unique key 28 is paired to the receiver assembly 18 so that only the holder of the key 28 can have access to information about the physical location of the beacon 12.

In the example shown in FIG. 3, the key 28 is affixed to a strap 30 bound to the hand 32 of the parent. The key 28 may be a proximity key such as a radio frequency identification (RFID) tag, blue tooth or other commonly available wireless communication technology. When the unique key 28 is in range of the receiver assembly 18, the receiver assembly 18 is activated or unlocked and the beacon's 12 positional information is made available for display. This way only the holder of the key 28 can access the location broadcast from the beacon 12.

In this example it is preferable to have a short distance proximity key 28 so that only the intended receiver assembly 18 can view the positional information. For example, since the key 28 may be on a wrist, purse or pocket of the parent, it may only need to be a predetermined distance from the receiver assembly 18, for example, approximately three feet away from the receiver assembly 18. A key 28 further than that predetermined distance would not be effective to unlock the broadcast location from the beacon 12.

To further enhance security of the system, the beacon 12, receiver assembly 18 and key 28 have a feature whereby they are all synchronized in a handshake procedure before they system is put into actual use. For example, before the child is let free in the shopping mall the beacon 12, receiver assembly 18 and key 28 are physically held near each other so that they all have and can recognize and establish a unique digital fingerprint common to the three components. This would prevent someone with another receiver assembly 18 from being able to clone or otherwise gain access to the positional data information broadcast by the beacon 12 because it would not have the unique digital fingerprint.

Similarly, if either the key 28 or the receiver assembly 18 was lost or stolen it would not be able to function to receive position information from the beacon 12. The only way for the beacon's 12 information to be read would be if the correct key 28 was in close proximity to the receiver assembly 18 and they both had matching fingerprints that also in turn match the finger print of the beacon 12. In other words the positional information of the beacon 12 would only be available if all of the components were present. Any single component would not be able to access that information.

Alternatively, the key 28 could be a physical key that positively inserts into a fixture on the receiver assembly 18. Engagement of the physical key 28 into the receiver assembly 18 could automatically initiate the handshake procedure outlined above for the wireless key 28. It may then be beneficial to have the physical key 28 attached to the parent so that if the receiver assembly 18 is lost, stolen or otherwise not in possession of the proper user, that the key 28 would not be with the receiver assembly 18 thereby making available the location of the beacon 12. In other analogous words, this avoids the mistake of leaving the keys in the running car while the driver is away.

The receiver assembly 18 shown in FIG. 2 is but one example of how the mapping device could be manifested. This proprietary receiver assembly could be touch screen activated and/or could have controls 24 built into the receiver assembly 18. The controls 24 may have hot buttons for emergency assistance requests or simply for navigation through operating system menus.

Another option for a physical button 24 is for the synchronization and handshake procedure. By requiring a physical button controls 24 to be pressed when the beacon 12, receiver assembly 18 and key 28 are all next to each other, the risks of cloning the unique fingerprint may be reduced because the physical act of pressing the controls 24 with the digital act of assigning the unique fingerprint to the devices.

Now referring to FIG. 4 where an alternate to the beacon 12 and strap 14 combination is shown include, inter alia, a shirt 34 and a beacon 36. The beacon 36 is functionally the same as beacon 12 shown in the figures and described above. This configuration may be useful to avoid the loss or removal of the beacon 36. For example, if the invention is to be used to monitor a nursing home resident or a small child it could be possible for a beacon 12 such as the wristwatch-style shown in FIG. 1 to be removed. Conversely, a beacon 36 affixed to a shirt 34 is much more difficult to remove.

Similarly, a beacon 36 could be placed in other articles of clothing, backpacks, wheel chairs, integrated in cell phones or other handheld electronic devices or other articles carried on or about the person being monitored.

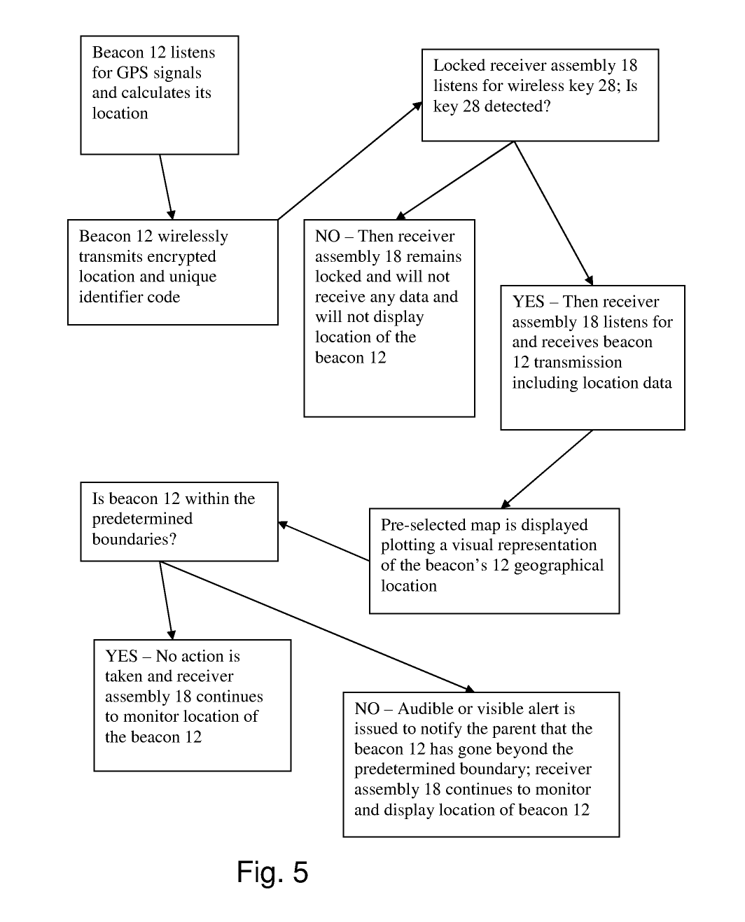

Now referring to FIG. 5 where an example of the logic process is demonstrated to comprise the beacon 12 listening for GPS signals and then calculating its own position. The encrypted location information is wirelessly transmitted with a unique identification code. The identification code may be necessary to allow multiple systems to be used simultaneously, for example, by several families in the same shopping mall.

The receiver assembly 18 is locked by default and continually listens for a nearby correct wireless key 28. When the proper wireless key 28 is detected the location data from the beacon 12 is received, interpreted and displayed on the display 20 then plotted on a pre-selected map of the location. The receiver assembly 18 checks to determine if the beacon 12 is within the pre-determined area and if not then an alert is issued so that appropriate action may be taken.

An important variation of the invention can be described as an electronic locator system comprising a beacon, a display assembly and a key, each working together. Said beacon receives global positioning data and calculates a geographical location of the beacon. Cellular network or satellite based GPS system could provide the data that the beacon can use to calculate its position. Said beacon encrypts said geographical location and wirelessly broadcasts the geographical location of the beacon. By encrypting the location data it is unreadable to anyone without the means to decrypt it. The display assembly is capable of receiving the encrypted geographical location and is capable of decrypting the geographical location of the beacon only when in close proximity to said key. The key could be any physical object that when brought near to or inserted into the display assembly the location of the beacon can be accessed. The key could be a common metal key, a magnetic swipe card, RFID tag or other commonly available means to positively identify a unique key. Said display assembly displays a graphical representation of the location of the beacon. For example, a map plotted with a point representing the beacon. Said display assembly issues an alert if a predetermined event occurs.

In another variation of the invention it can be further characterized in that said predetermined event is defined as when the beacon crosses a predetermined geographical boundary. For example, the perimeter of a building, a gate, land boundary, distance from the display assembly or other definable geographical location.

Another optional variation of the invention can be further characterized in that said beacon can be removably affixed to a human wrist. For example, a wristwatch-like form.

Yet another variation can be further characterized in that said beacon can be integrated into an article of clothing, a wheel chair, a bag, a purse, a backpack or a vehicle. This would permit the holder of the key and display assembly to monitor a wide variety of people in a wide variety of applications.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. An electronic locator system comprising a beacon, a display assembly and a key;
Said beacon receives global positioning data and calculates a geographical location of the beacon;
Said beacon encrypts said geographical location and wirelessly broadcasts the geographical location of the beacon;
Said display assembly is capable of receiving the encrypted geographical location;
Said display assembly is capable of decrypting the geographical location of the beacon only when in close proximity to said key;
Said display assembly displays a graphical representation of the location of the beacon;
Said display assembly issues an alert if a predetermined event occurs.

2. An electronic locator systems as described in claim 1 further characterized in that said predetermined event is defined as when the beacon crosses a predetermined geographical boundary.

3. An electronic locator systems as described in claim 1 further characterized in that said beacon can be removably affixed to a human wrist.

4. An electronic locator systems as described in claim 1 further characterized in that said beacon can be integrated into an article of clothing, a wheel chair, a bag, a purse, a backpack or a vehicle.
